(19) United States
(12) Patent Application Publication
(10) Pub. No.: US 2007/0014289 A1
(43) Pub. Date: Jan. 18, 2007

(54) Systems and methods of multicast transport call session control for improving forward bandwidth utilization

(76) Inventor: Timothy F Settle, Leesburg, VA (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/557,674

(22) PCT Filed: May 13, 2004
(86) PCT No.: PCT/US04/14967

§ 371 Date: Nov. 18, 2005

Related U.S. Application Data
(60) Provisional application No. 60/472,254, filed on May 21, 2003.

(51) Int. Cl. H04L 12/56; H04L 12/42

(52) U.S. Cl. 370/390; 370/450

(57) ABSTRACT

Methods and systems of for multicast transport call session control for improving forward bandwidth utilization are disclosed. Forward channel bandwidth utilization is improved through pipelining and in-band token control of the multicast protocol when there exists a multiplicity of data objects for delivery from the server (202) to the clients (208).

This application claims priority to U.S. Provisional Application No. 60/472,254, filed May 21, 2003, the entire contents of which are hereby incorporated by reference.

### FIELD OF THE INVENTION

This invention relates generally to telecommunication networks such as Internet Protocol (IP) networks using multicast delivery of non-real-time-data, and, more particularly, systems and methods of multicast transport call session control using pipeline overlay on multi-threaded processes and token control for improving forward bandwidth utilization.

### BACKGROUND OF THE INVENTION

Multicast data delivery using a one source to many destinations communications model is widely used for media distribution, including media distribution by satellite. A push model for data delivery entails sending data from a source site to associated destination or client sites based on a delivery schedule maintained at the source site. In a pull model for data delivery, the delivery schedule is maintained at the destination site or sites, meaning data is delivered to a destination site on command from the destination site. Pull models generally do not restrict destination sites to issuing delivery commands synchronously, and thus, in a pull model, data delivery to individual destination sites is independent as to when data is to be delivered. For this reason, the pull model causes scheduling complexities for the source site and is generally less efficient in terms of bandwidth used to deliver the data.

A many-to-many or one-to-many multicast push model for media distribution offers manageable delivery scheduling as well as improved bandwidth efficiencies. Multicasting offers improved bandwidth efficiencies by using the bandwidth once for data delivery as opposed to using the bandwidth several times for each intended receive destination. Generally, many-to-many IP multicasting entails a dialog between server computers and client computers over an IP network that connects the servers to the clients. A one-to-many IP multicasting model involves one server computer and many client computers. A set of rules controls the server-client dialog and governs the sequence of communication events between the servers and clients. These rules are collectively referred to as a protocol, and in the case of IP multicasting, an IP multicasting protocol. A call session is the server-client dialog.

Some applications of media distribution include news story delivery to television broadcast stations, syndicated program delivery to television stations, corporate updates to geographically diverse company sites, and educational material to several learning sites. In each of the above cases, a multicast model of any variety may be applied, that is to say, any combination of push model or pull model with many-to-many or one-to-many multicast delivery. Many content distribution networks either own or lease bandwidth capacity that enables their distribution network to operate. In either case, bandwidth is a precious commodity that should be optimized for usage in order to minimize costs and maximize content distribution service. An example is a satellite-based IP network where satellite transmission is the medium by which content is multicast to several receive locations on a scheduled basis. In this example, the bandwidth commodity is satellite transponder capacity. Although existing multicast systems provide improved bandwidth over prior systems, room for improvement remains.

Accordingly, there is a need for systems and methods of multicast delivery of non-real-time-data that provide more efficient utilization of forward bandwidth in order to minimize costs and maximize content distribution.

### SUMMARY OF THE INVENTION

Certain exemplary embodiments according to the present invention provide systems and methods for multicast transport call session control for improving forward bandwidth utilization. According to certain exemplary embodiments of this invention, forward channel bandwidth utilization is improved through pipelining and in-band token control of the IP multicast protocol when there exists a multiplicity of data objects for delivery from the server to the clients. Certain exemplary embodiments of this invention provide improved pipeline architecture for an IP multicast protocol, passing tokens in order to control sending data through a forward channel in accordance with the architecture of the pipeline, and improved forward channel bandwidth utilization and efficiency.

An exemplary environment for operation of certain exemplary embodiments of this invention is a one-to-many multicast IP network environment. For instance, the one-to-many multicast IP network may be a hybrid IP multicast network where the forward channel is a satellite link between the server and clients and the back channel from the clients to the server is terrestrial.

According to certain exemplary embodiments of the present invention, each call session in a pipeline operates as a separate virtual or logical channel within the physical forward channel. A pipeline is constructed using a central control from which multiple child processes may be initiated. Each child process constitutes one IP multicast call session. Based on the depth of the pipeline constructed, a group of IP multicast call sessions form a pipeline according to their predefined IP multicast call session process steps. The central control is responsible for creating and controlling the pipeline, determining when an IP multicast call session or sessions may send data through the forward channel. In an exemplary embodiment, a token or group of tokens maintains at least partial control of the pipeline. One or more IP multicast call sessions use a token or tokens to send data through the forward channel. If multiple tokens are used, then multiple IP multicast call sessions are allowed to send data through the forward channel simultaneously.

In one embodiment, a method for multicast delivery of a plurality of call sessions, each call session comprising at least one send data process step and at least one wait process step, includes (a) providing a send token that controls which of the plurality of call sessions sends data through the forward channel; (b) moving the send token to a first call session at a send data process step; (c) upon reaching a wait process step of the first call session, moving the send token to a second call session at a send data process step; (d) upon reaching a wait process step of the second call session or any subsequent wait process step of any of the plurality of call sessions, moving the send token to an active call session that is at a second or subsequent send data process step or, if no active call sessions are at a send data process step, moving the send token to an uninitiated call session of the plurality of call sessions; and (e) repeating (d) until delivery of each of the plurality of call sessions is complete. The telecommunications network may be a one-to-many internet protocol network with a satellite forward channel and a terrestrial back channel. Step (d) may include moving the send token to an active call session at a second or subsequent send data process step based on a priority scheme. The priority scheme may be that the earliest initiated call session receives the send token when the send token becomes available. Step (d) may include moving the send token to an uninitiated call session according to an order in a queue of uninitiated call sessions. In another embodiment, a method of multicast delivery may include providing a second send token such that two call sessions may send data simultaneously through a forward channel of the network.

### BRIEF DESCRIPTION OF THE DRAWINGS

FIG. 1 depicts an exemplary network topology for a one-to-many multicast network environment.

FIG. 2 shows an exemplary network topology for a one-to-many hybrid IP multicast network environment.

FIG. 3 shows a logical layer embodiment of the hybrid multicast network environment of FIG. 2.

FIG. 4 illustrates an exemplary embodiment of process flow for mapping call sessions to logical channels based on digital video broadcast standard packet identifiers.

FIG. 5 shows an exemplary embodiment of process flow for an exemplary multicast call session.

FIG. 6 shows an exemplary embodiment of parent-controlled processes for controlling a pipeline.

FIG. 7 illustrates relative sizes of exemplary multicast delivery jobs depicted in FIGS. 8A-9F.

FIGS. 8A-8G show an exemplary embodiment of multicast delivery of multiple call sessions using a token-controlled pipeline according to the present invention.

FIGS. 9A-9F show multicast delivery of multiple call sessions using existing systems and methods of serial delivery.

### DETAILED DESCRIPTION OF THE INVENTION

Certain exemplary embodiments according to the present invention provide systems and methods for multicast transport call session control for improving forward bandwidth utilization. These exemplary embodiments are merely preferred embodiments of the invention; other embodiments of the invention may be implemented by persons skilled in the art. According to certain exemplary embodiments of this invention, forward channel bandwidth utilization is improved through pipelining and in-band token control of the IP multicast protocol when there exists a multiplicity of data objects for delivery from the server to the clients.

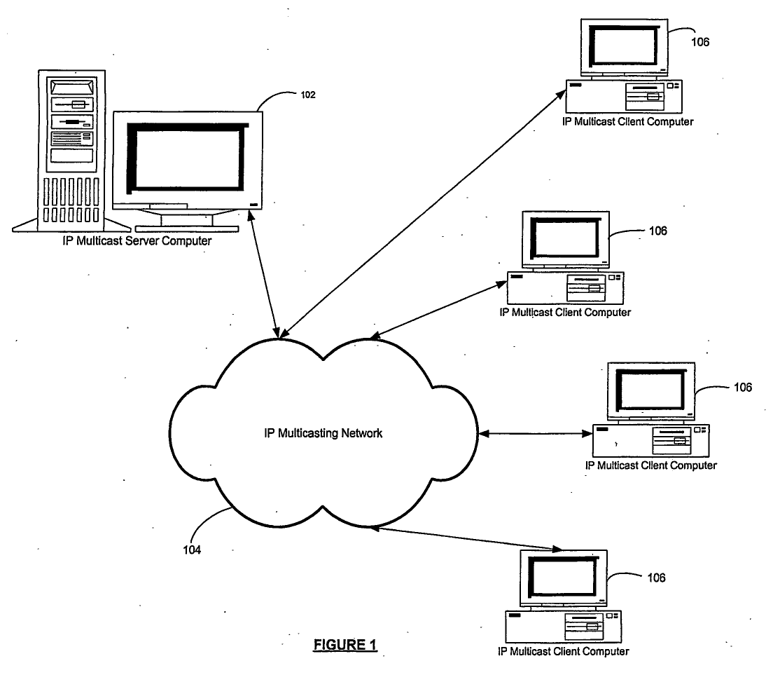

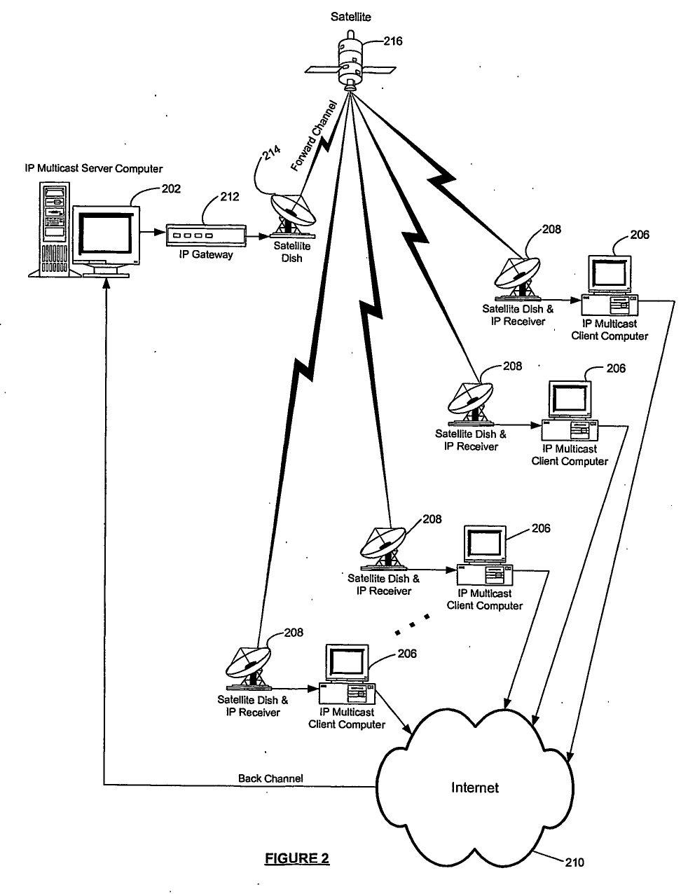

FIG. 1 shows an exemplary embodiment of a one-to-many multicast IP network environment. The environment shown in FIG. 1 is a multicasting push model, but it should be understood that systems and methods of the present invention may be used with pull models as well as many-to-many multicast networks. According to push models, a multicast server 102 schedules and distributes content to several multicast clients 106 over an IP multicast network 104. IP multicast network 104 may be terrestrial based, satellite based, optical, terrestrial wireless, or any other type of IP multicast network well known to those skilled in the art. An example of a typical IP multicast network is shown in FIG. 2.

FIG. 2 shows an exemplary embodiment of a one-to-many multicast network environment with a hybrid IP multicast network. As shown in FIG. 2, the forward channel is a satellite link between the server and clients, and the back channel from the clients to the server is terrestrial. The multicast network in FIG. 2 is referred to as a “hybrid” network because it includes a forward channel and a back channel that deliver data via different means (e.g., a wireless forward channel and a wireline back channel). The server, via an IP multicast server computer 202, an IP gateway 212, and a satellite dish 214, communicates with a satellite 216, that in turn communicates with numerous clients, each with a satellite dish and IP receiver 208 and an IP multicast client computer 206. This is the forward channel. IP multicast client computers 206 communicate with IP multicast server computer 212 via Internet 210. This is the back channel.

As previously noted herein, content distribution via IP multicasting may require distribution scheduling by the multicast server or servers for delivering content data objects over the network to destination clients. Often, content distribution involves a plurality of diverse content data objects that require distribution to designated clients over a specified time period. In such situations, the forward channel bandwidth may be optimized for high usage based on scheduling and the methodology employed by an IP multicasting protocol. For example, if a batch of data objects are scheduled for delivery, one technique is serial delivery, which entails sending one job at a time and including a waiting period between each data object delivery session. Waiting periods arise as a natural consequence of the multicasting call session protocol chosen because there exist portions of a multicast call session where no data is being sent through the forward channel. The measured forward channel utilization is far less than 100% using this serial delivery technique.

Modem operating systems for servers and client computers permit multiple computing processes to coexist. Operating systems that have this capability are known as multi-tasking operating systems. Computer programs that exploit multi-tasking operating systems do so by utilizing multiple program threads that operate on different tasks simultaneously. Certain exemplary embodiments of this invention utilize multi-threading by overlaying a pipeline structure for the processing steps executed during a call session for an IP multicast protocol. Pipelining permits servicing several data objects for multicast delivery as each delivery call session is in a different stage of its respective multicast delivery. Multiple multicast call sessions are processed and coordinated by using an in-band control scheme that preserves the pipeline structure and ensures improved forward channel bandwidth utilization compared to serialized management of different call sessions.

According to certain exemplary preferred embodiments of the present invention, each call session in the pipeline operates as a separate virtual or logical channel within the physical forward channel. It is common to refer to a physical channel based on physical characteristics, such as transmission frequency, transmission bandwidth, and in the case of satellite communications, spatial orbit. A virtual or logical channel is generally defined by an addressable parameter, such as IP address or packet identifier (PID) addresses.

Most digitally-based satellite communications systems use standard packet based transport concepts defined by the digital video broadcast (DVB) standard. The DVB standard for satellite communications permits logical channel assignments based on PID values assigned to packets of data. For example, either DVB or some other logical channel assignment standard would be used in the exemplary environment shown in FIG. 2. FIG. 2 shows an IP gateway that receives IP packets from a multicast server. The IP gateway encapsulates the received packets into another addressable packet scheme such as DVB. The concept of logical channels permits segmenting of a physical channel into several logical channels through time division multiple access (TDMA) methods, which are well known to those skilled in the art. For more information regarding IP packet addressing, the reader is referred to “RFC791,” and for information on DVB packet addressing and DVB encapsulation, the reader is referred to “ISO/IEC 13818-1 Generic coding of moving pictures and associated audio information: Systems” and “ISO/IEC 13818-6 Generic coding of moving pictures and associated audio information—Part 6: Extensions for DSM-CC,” respectively, each of these documents being well known to those skilled in the art and incorporated herein by reference in their entirety.

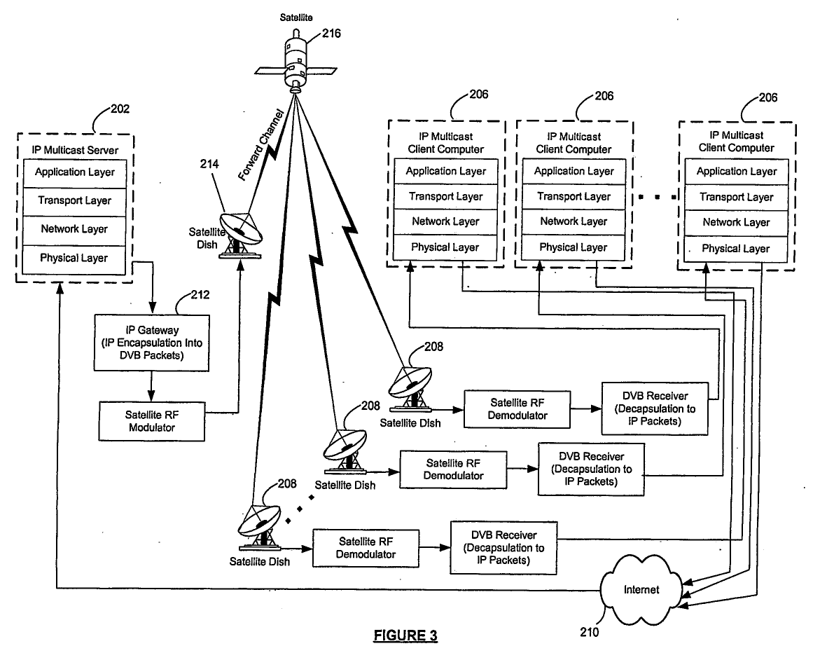

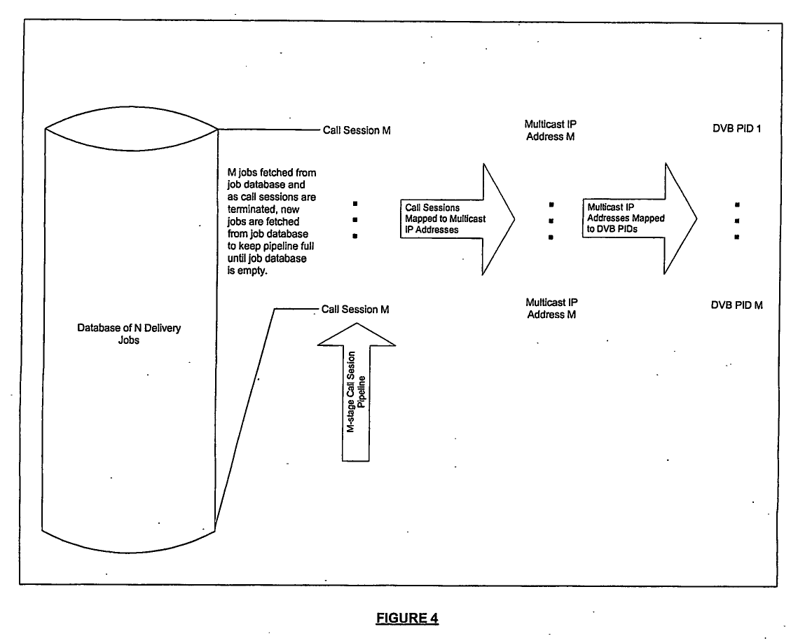

FIG. 3 shows a logical layer embodiment of the hybrid multicast network environment of FIG. 2. FIG. 4 illustrates an exemplary embodiment of process flow for mapping call sessions to logical channels using DVB standard PIDs. As shown in FIG. 4, there is a multiplicity of call sessions or delivery jobs (N jobs) accessible from a database. Initially, delivery jobs are fetched until the depth of the call session pipeline has reached capacity, M jobs in this example. Once the call session pipeline is full, the, next delivery job is fetched upon termination of an active call session, placing a new delivery job in the vacated pipeline position. With proper coordination among delivery jobs in the call session pipeline, improved forward channel bandwidth utilization is achievable.

A call session in an IP multicast protocol generally includes a set of process steps. Generally, a call session includes three fundamental operations: (1) call setup, (2) call data send (i.e., sending the delivery job data through the forward channel); and (3) call termination. In some instances, an IP multicast delivery network handles mission critical jobs where a back channel is used so that delivery sites may notify the multicast server when a portion of the delivery job was not received. When notification arrives, the multicast server resends missed portions of the delivery job to all receive clients that indicated a portion was not received through their respective back channels. Therefore, sending a delivery job through the forward channel may entail several iterations in order to ensure reliable job delivery. The environments shown in FIGS. 2 and 3 incorporate a back channel for notification of missing portions of a delivery job and/or confirmation of delivery success. An Internet back channel is shown in each figure, but any other suitable back channel means may be used, as is well understood by those skilled in the art. For example, a satellite back channel based on very small aperture terminal (VSAT) technology may be used.

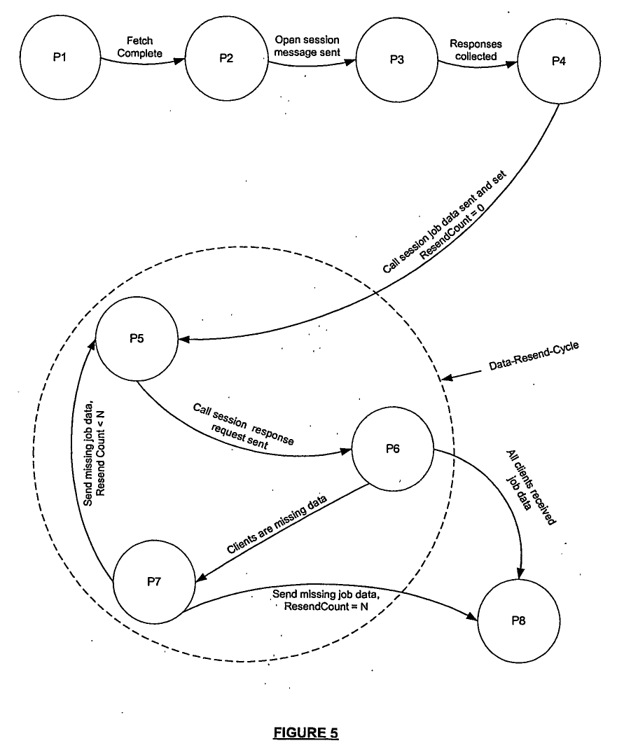

FIG. 5 shows an exemplary embodiment of process flow for an exemplary IP multicast call session from the perspective of a multicast server. As noted herein, there are three broad categories for these process steps: process steps that send data through the forward channel; process steps that perform non-sending or non-receiving operations of a call session; and process steps that receive data from the back channel. A more refined and detailed example of an IP multicast call session operational protocol, including eight process steps, is shown in FIG. 5 and described further below. It should be noted that process steps P3-P8 show the actual call session dialog between the multicast server and the multicast clients.

State transition rules for the exemplary IP multicast call session shown in FIG. 5 are as follows: (a) each process step or state may have multiple entry points and multiple exit points; (b) if a process step or state has multiple input arrows to the same entry point, it is an indication that the process step or state may start only after all input arrows convey a true condition; (c) if a process step or state has an input arrow or arrows to two or more entry points, then that process step or state is started upon the first occurrence of either entry point conveying a true condition considering all inputs to that entry point; and (d) if a process step or state has more than one exit point, then that process step state may exit based on different exit conditions.

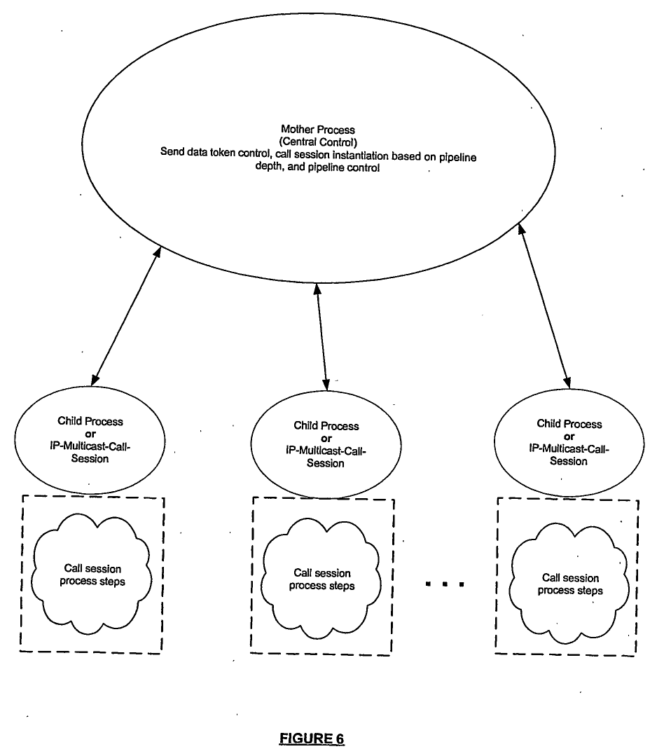

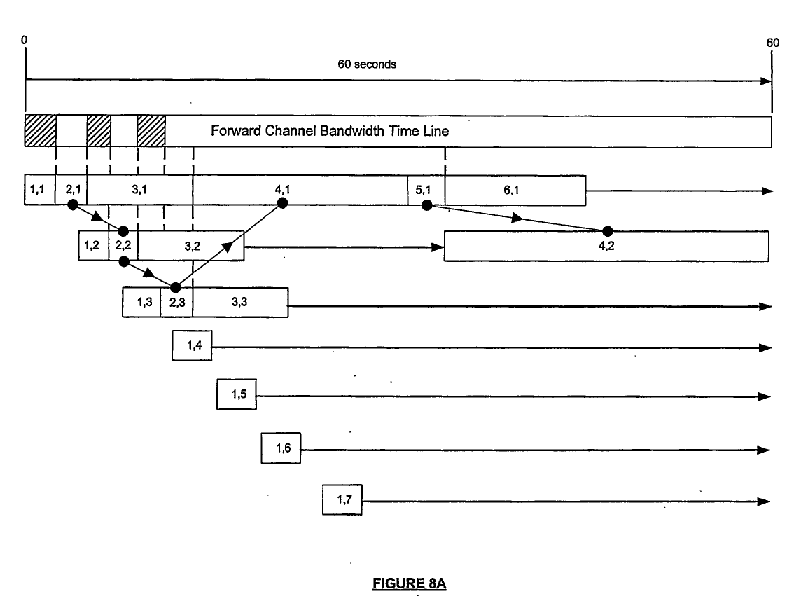

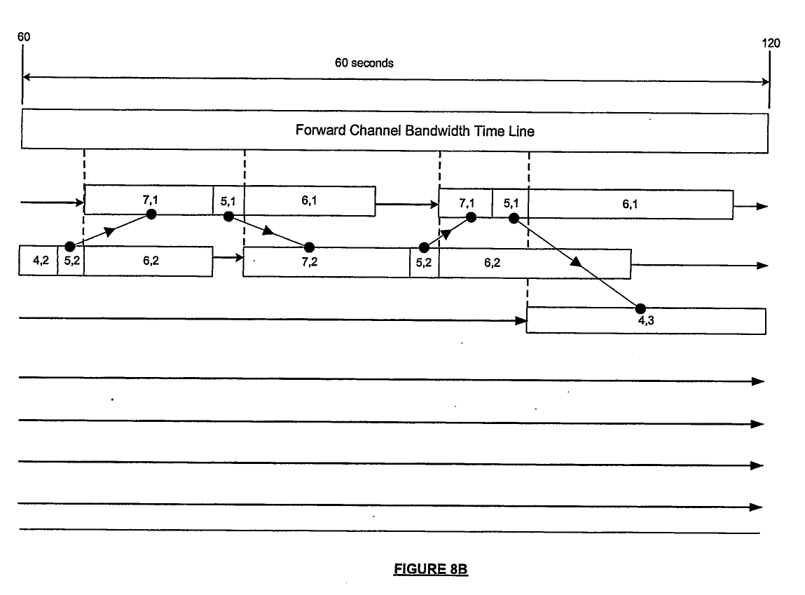

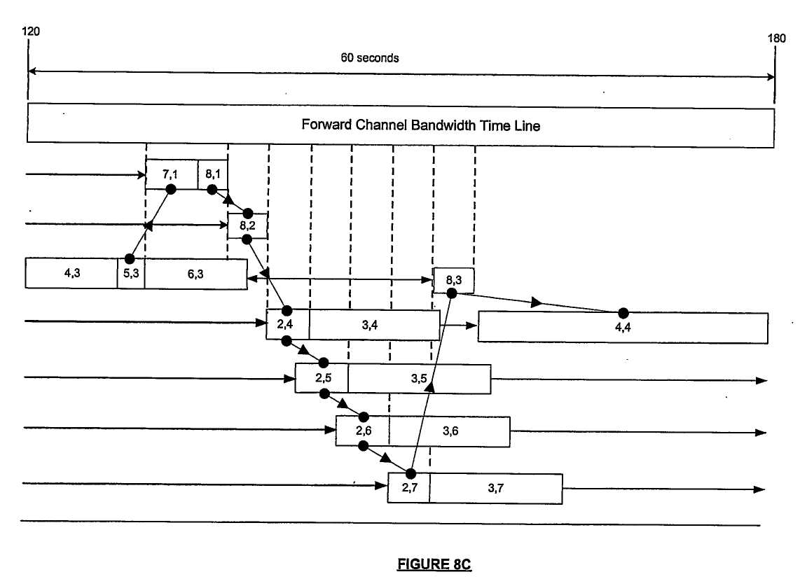

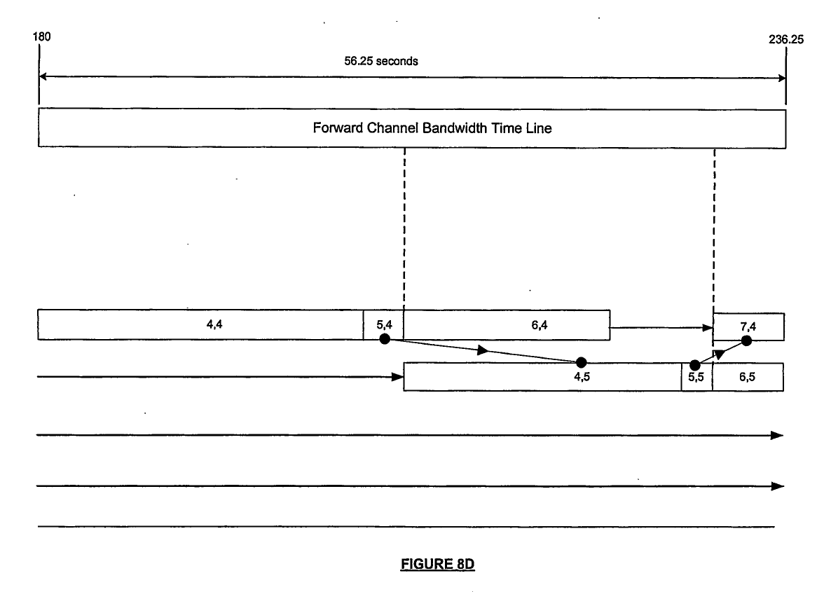

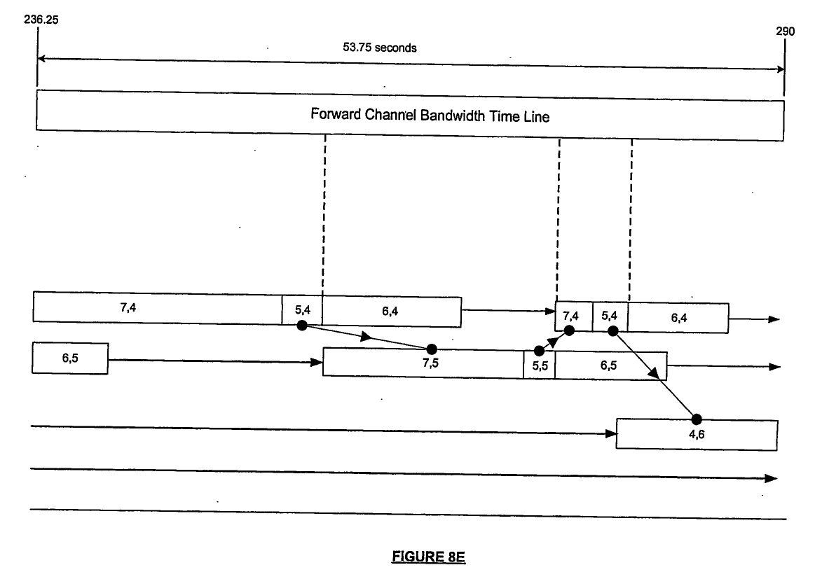

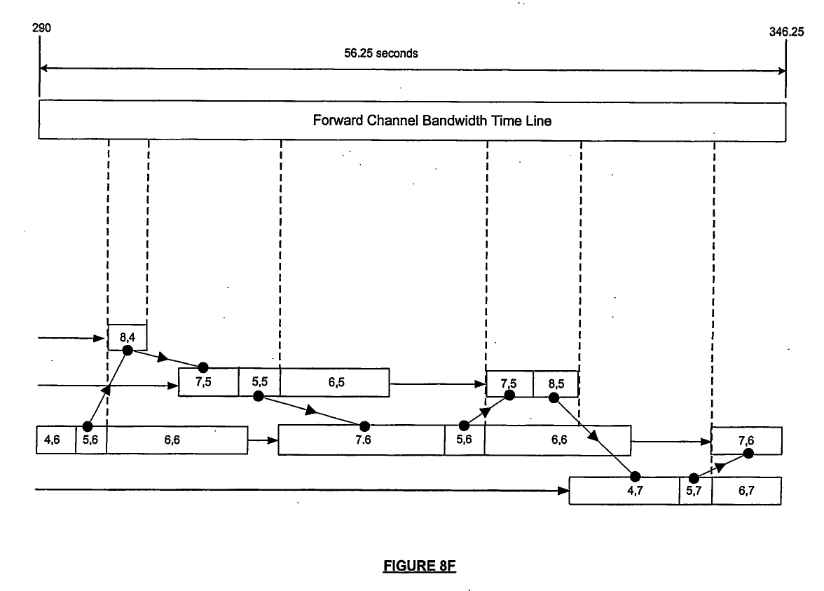

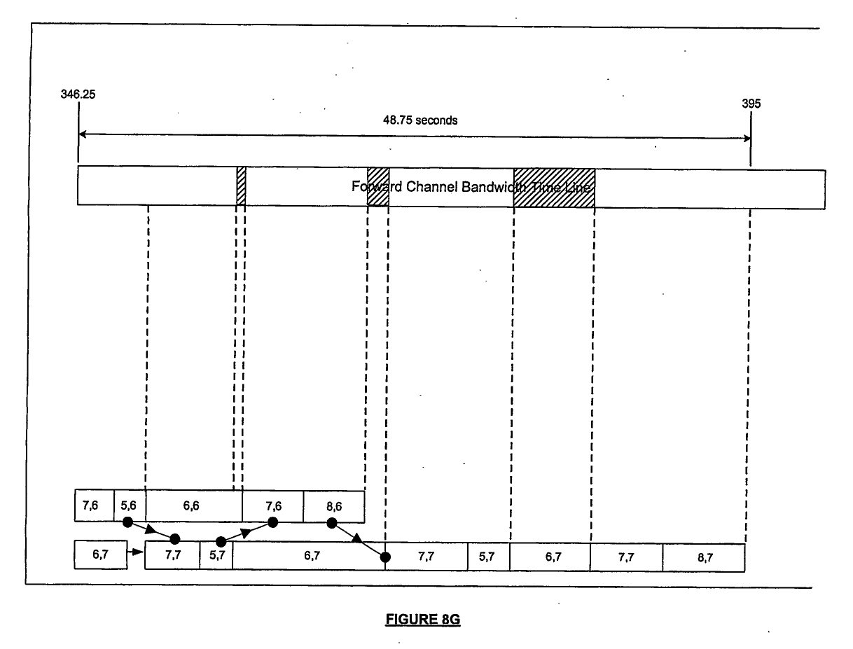

The process steps outlined in the exemplary embodiment shown in FIG. 5 provide a particular example of an IP multicast transport protocol. It should be understood that systems and methods of the present invention are not limited to the exemplary eight-step IP multicast call session protocol described herein and that the present invention allows numerous embodiments of an IP multicast call session protocol to operate in a pipeline fashion with multi-threaded control rules such that forward channel utilization is optimized when there exists a multitude of distribution jobs. Other aspects according to systems and methods of the present invention, such as pipeline architecture, are shown in FIGS. 6 and 8A-8G and described in detail below. FIG. 5 does not include any pipeline or associated control and illustrates an event driven process transition diagram (i.e., process transitions are based on event outcomes).

Referring now to FIG. 5, each of the eight exemplary process steps, P1 through P8, are as follows:

P1: Fetch Call Session Job.

The call session job is fetched from the job queue. Generally, but not always, multicast delivery jobs are held in an accessible storage medium, such as a standard database.

P2: Send Open Call Session Message.

An open call session message is sent to the designated receive clients. This message officially opens a call session to a designated pool of clients. The client list is typically unique for each multicast job, but the client list may be fixed for all multicast jobs.

P3: Collect Open Call Session Responses.

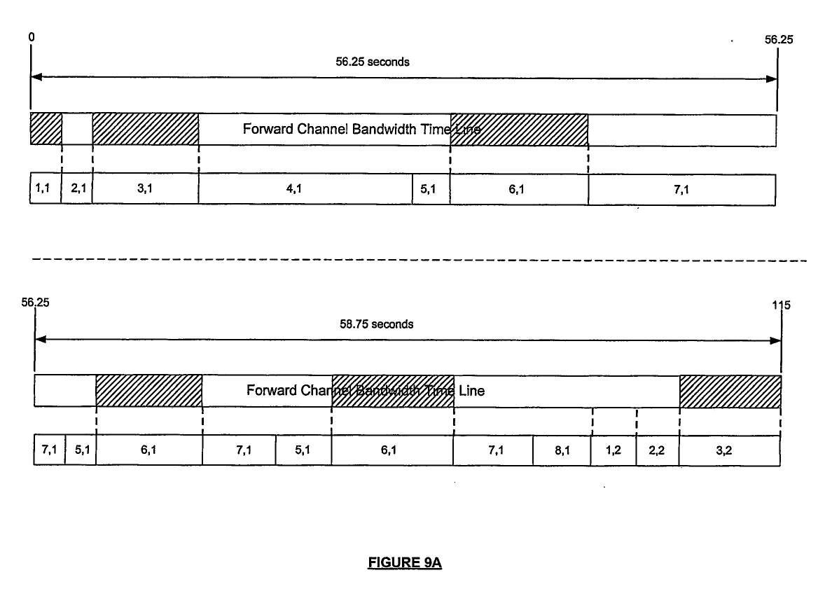

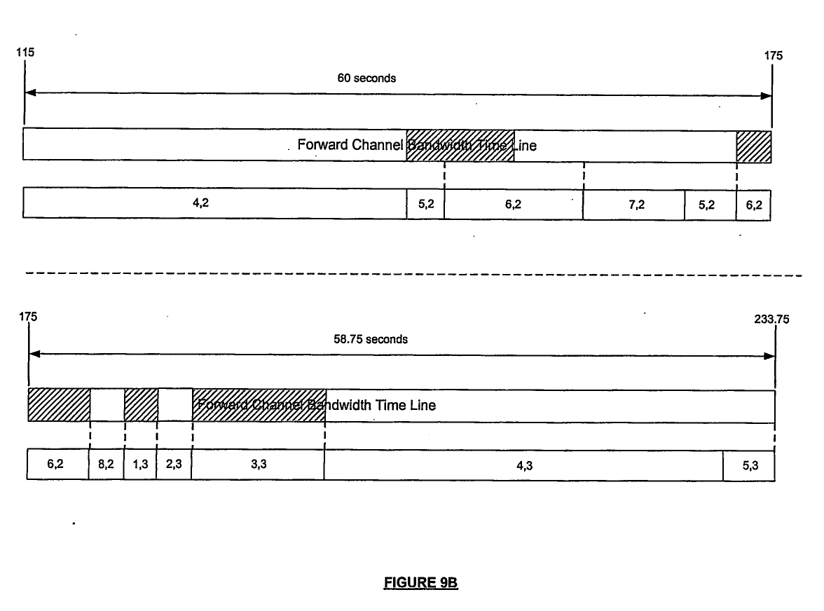

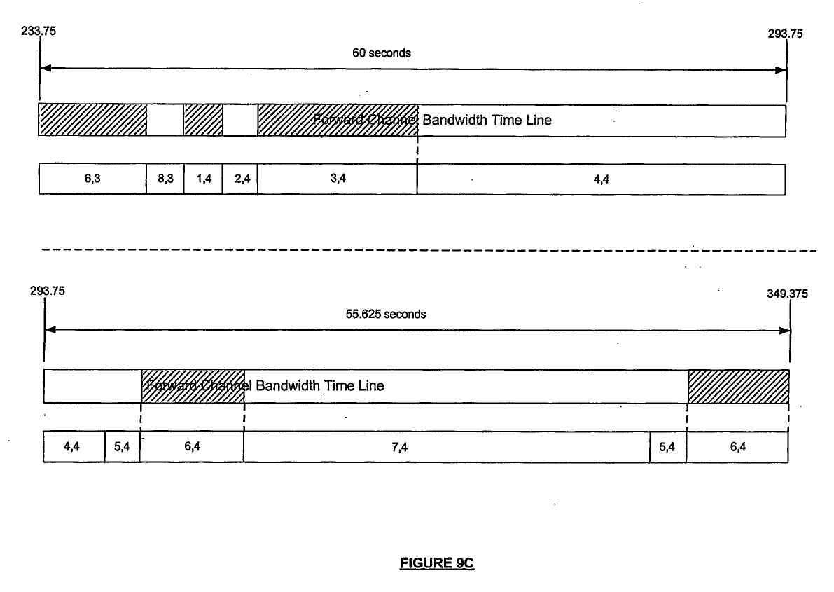

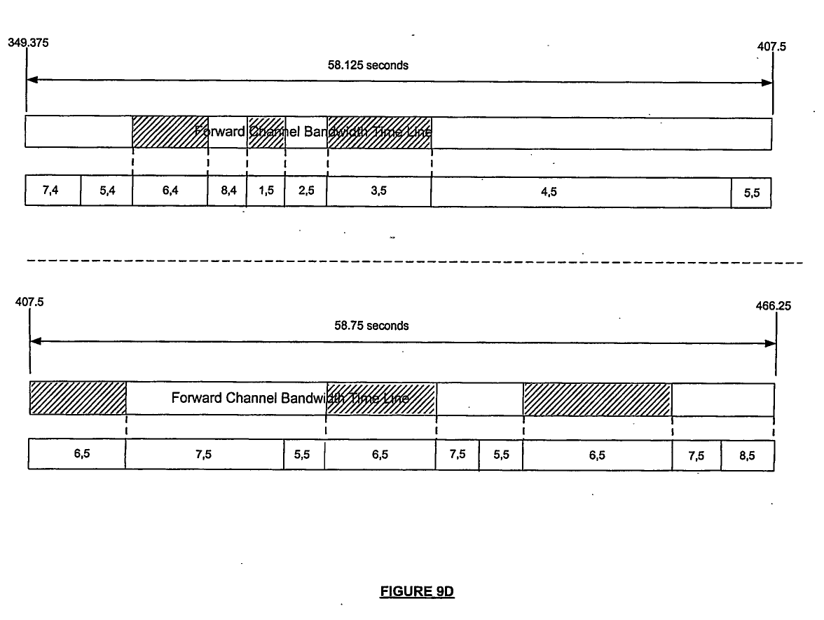

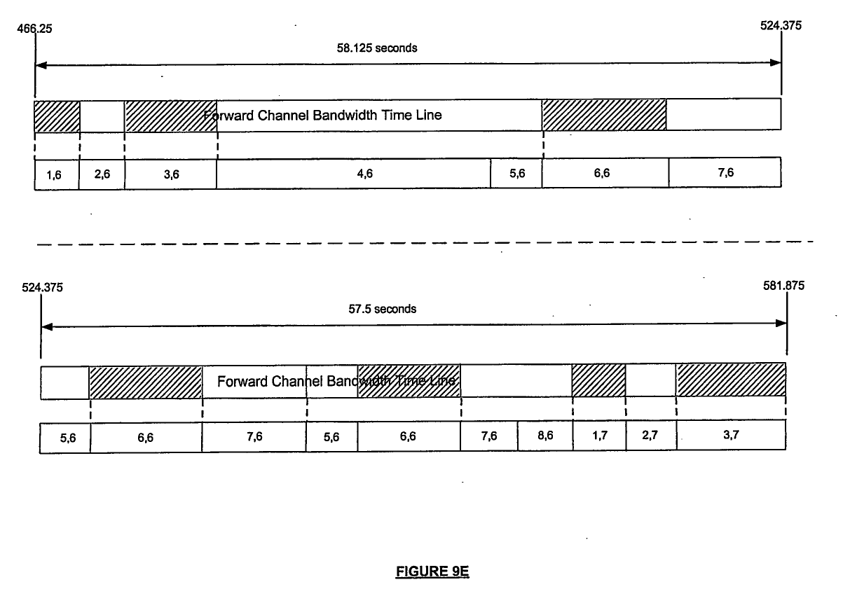

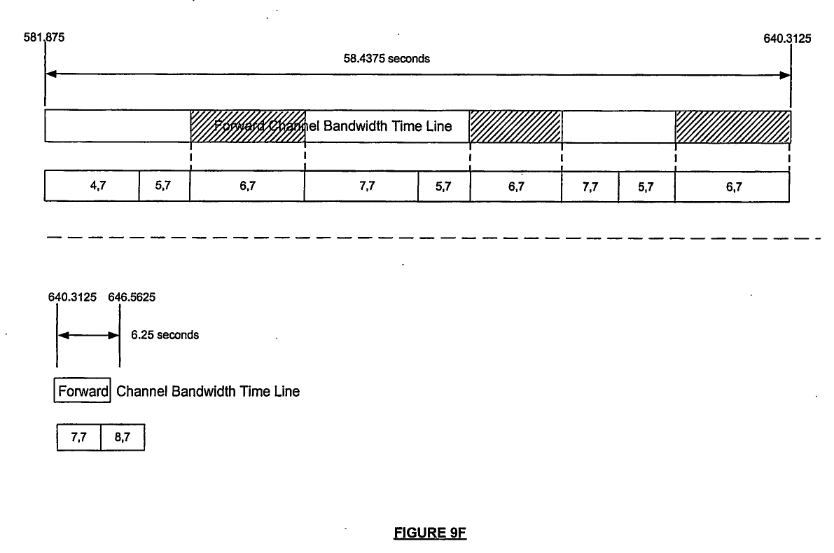

Responses to the open call session message are collected from designated clients. Because clients are normally physically remote, it is necessary to assess which clients within the client pool are ready for a call session. If all the designated clients respond, normal operations may proceed. However, if less than the total number of designated clients respond, some other appropriate action may be taken, such as continuing with the call session or terminating the call session immediately. In the call sessions shown and described in FIGS. 8A-9F, it is assumed that all of the designated clients respond and normal operations proceed. This step is a waiting process (i.e., no data is being sent). If no other process is sending data during this time; then the forward bandwidth is not used during this wait period. In the call sessions shown and described in FIGS. 8A-9F, it is assumed that this waiting period is a known, fixed time period for all multicast jobs distributed.

P4: Send Call Session Job Data and Reset Resend Count to Zero.

The size of each delivery job is time-varying. A resend counter in this particular IP multicast call session protocol facilitates resending missing job data multiple times. The resend counter is not required but it is prudent to allow for resending missing job data in cases where delivery jobs are mission critical. The resend count controls how many times the multicast server will attempt to send a job to the multicast client pool before terminating the call session so that other delivery jobs can be serviced.

P5: Send Call Session Response Request and Increment the Resend Count.

This message obtains feedback from the designated client pool on missed job data. Positive acknowledgement messages or negative acknowledgement messages convey this information. Other suitable acknowledgement message systems, which are well known to those skilled in the art, may be used. This process step increments the resend counter and is the first step in a loop (P5 through P7) that assesses multicast client reception to determine if sending missing job data is required.

P6: Collect-Call-Session-Responses from Designated Clients and Check Multicast Clients Reception Status.

This process step analyzes the reception status of the multicast client pool. If missing job data needs to be sent, the protocol moves to P7. If all clients have received the job data, the protocol moves to step P8. This step is a waiting process (i.e., no data is being sent, similar to P3). In the call sessions shown and described in FIGS. 8A-9F, it is assumed that this waiting period is a known, fixed time period for all multicast jobs distributed. P6 is the second step in a loop (including P5-P7) that assesses the multicast client pool reception status to determine whether to resend missing job data or terminate the call session.

P7: Resend-Missing-Call-Session-Job-Data and Check if the Resend Count has Reached its Maximum Allowed Value.

This process step has two exit points. For either exit point, missing job data is sent to the multicast client pool. The exit points are determined based on the status of the resend count. If the resend count has reached its maximum allowed value (N), then missing job data is sent and the process moves to P8. If the resend count is less than its maximum allowed value, then missing job data is sent and the process continues with P5. In an instance where job delivery to all designated clients is mission critical, there may be several cycles of sending a request for job acknowledgement, collecting responses, and resending missing call session data; generally referred to as a Data Resend Cycle. Due to the heterogeneous nature of the client pool, the number of times a Data Resend Cycle is necessary to achieve complete delivery of job data to all designated clients is unknown and random. Therefore, most IP multicast delivery systems fix the number of Data Resend Cycles based on achieving delivery to a majority of the designated clients. This value is the maximum allowed value for the resend count, N. Typically, an IP multicast delivery system reschedules clients for a later multicast when they do not reliably receive all the job data after exhausting all Data Resend Cycles. A Data Resend Cycle generally includes execution of the following process steps: P5, P6, and P7.

P8: Send Close Call Session Message.

This message officially terminates a call session.

A pipeline is constructed using a central control from which multiple child processes may be initiated, as shown in FIG. 6. Each child process constitutes one IP multicast call session. Based on the depth of the pipeline constructed, a group of IP multicast call sessions form a pipeline according to their predefined IP multicast call session process steps. The central control is responsible for creating and controlling the pipeline, determining when an IP multicast call session or sessions may send data through the forward channel.

In an exemplary embodiment, a token or group of tokens maintains at least partial control of the pipeline. Tokens are used by one or more IP multicast call sessions to send data through the forward channel. If multiple tokens are used, then multiple IP multicast call sessions are allowed to send data through the forward channel simultaneously. For simplicity, the exemplary preferred embodiment described herein with reference to FIGS. 8A-8G utilizes a single token. In the exemplary embodiment, each IP multicast call session exists as a logical channel mapped within the physical instance of the forward channel and employing TDMA methods. Logical channel mapping within the physical forward channel is described herein and shown in FIG. 4.

In an exemplary embodiment, central control manages pipeline flow based on the following rules:

(A) To ensure that the bandwidth is used during any process step that does not send data through the forward channel, pipeline depth is maintained such that another call session is at a pending send data process step. This may require a large number of pre-fetched call session jobs. Accordingly, unused bandwidth gaps may occur if the number of jobs available during a call session pre-fetch is less than the particular number of jobs necessary to maintain an ideal pipeline depth.

(B) To ensure that the pipeline maintains a flow of active call session jobs, call sessions jobs are pre-fetched whenever the predetermined pipeline depth has an open position. An open position in the pipeline depth is an indication that at least one call session job has terminated or completed.

(C) Each send process or state in a call session should possess the SEND-TOKEN in order to send data. After completing a data send, a call session relinquishes the SEND-TOKEN if its next process or state transition is a non-sending process or state. When several call sessions are vying for the SEND-TOKEN, a priority scheme may be employed. For example, call session age (i.e., the oldest call session gets priority over younger call sessions), call session priority (i.e., higher priority call sessions take precedence over lower priority call sessions), assigned quality-of-service (QoS) level priority (where certain call sessions are assigned a higher level QoS compared to others), any combination of the above, or any other suitable scheme well known to those skilled in the art. Implementing a priority scheme for controlling the SEND-TOKEN ensures that the SEND-TOKEN is available when the highest priority call session is able to send its associated data.

FIGS. 8A-8G show an exemplary preferred embodiment of multicast delivery of multiple call sessions using a token-controlled pipeline according to the present invention. In this embodiment, there are seven multicast call sessions, and for each, there are eight process steps, P1 through P8, as shown in FIG. 5 and described herein. As shown in FIGS. 8A-8G, a call session process step is identified by a set of two numbers, the first number indicating the process step (1 through 8 corresponding to the exemplary process steps P1 through P8 described herein) and the second number indicating the multicast call session (1 through 7). For example, the fourth process step of the second multicast call session is indicated by the set 4,2, the third step of the fifth call session is indicated by the set 3,5, and so on. In the exemplary embodiment shown in FIGS. 8A-8G, the number of Data-Resend-Cycles (i.e., P5-P7) is limited to three per call session and call session wait process steps P3 and P6 are equally fixed time lengths for all seven call sessions.

The shaded areas along the forward channel bandwidth timeline illustrate where bandwidth is unused, while the unshaded areas indicate where bandwidth is used. The horizontal lines (within each call session) ending in arrows indicate that a call session is in a pending process step that is ready to send data through the forward channel when the SEND-TOKEN becomes available. Diagonal lines (across call sessions) with an arrow in the middle and terminated with filled circles on both ends indicate how the SEND-TOKEN flows from one call session to another, with the arrow indicating the direction which SEND-TOKEN flows. In the exemplary embodiment shown in FIGS. 8A-8G, there is only one SEND-TOKEN, but the systems and methods according to this invention may use a plurality of send tokens. Using one SEND-TOKEN reduces the complexity of the system, while using more than one SEND-TOKEN allows more than one call session to send data through the forward channel bandwidth. The bandwidth timeline is segmented across each FIG. 8A-8G with each segment representing a time continuum to demonstrate where in time the forward channel bandwidth is used by a multicast call session according to this invention.

The pipeline depth of the embodiment shown in FIGS. 8A-8G is seven and is selected based on the exemplary rules discussed above and an arbitrary rule of not allowing the number of simultaneous call sessions to exceed seven. A random operation flow for each call session depicted in FIGS. 8A-8G is chosen to demonstrate how the pipeline and token control mechanism of this invention operate under various conditions. Table 1 shows the operation flow for each delivery job as depicted in FIG. 8A-8G.

TABLE 1
Example Operation Flow for Multicast Call Sessions

| Multicast Call | |
|---|---|
| Session | |
| Number | Multicast Operation Flow |
| 1 | Three Data-Resend-Cycles performed thus reaching the maximum |
| | allowed and hence terminating after sending the third resend data. Each |
| | succeeding resend data size is smaller then the previous. |
| 2 | One Data-Resend-Cycle with decreasing resend data size. |
| 3 | No Data-Resend-Cycle necessary as all clients received the delivery job |
| | after the initial send data step, process step P4. |
| 4 | Two Data-Resend-Cycles with decreasing resend data size. |
| 5 | Three Data-Resend-Cycles performed thus reaching the maximum |
| | allowed and hence terminating after sending the third resend data. Each |
| | succeeding resend data size is smaller then the previous. |
| 6 | Three Data-Resend-Cycles performed thus reaching the maximum |
| | allowed and hence terminating after sending the third resend data. Each |
| | succeeding resend data size is smaller then the previous. |
| 7 | Three Data-Resend-Cycles performed thus reaching the maximum |
| | allowed and hence terminating after sending the third resend data. Each |
| | succeeding resend data size is smaller then the previous. |

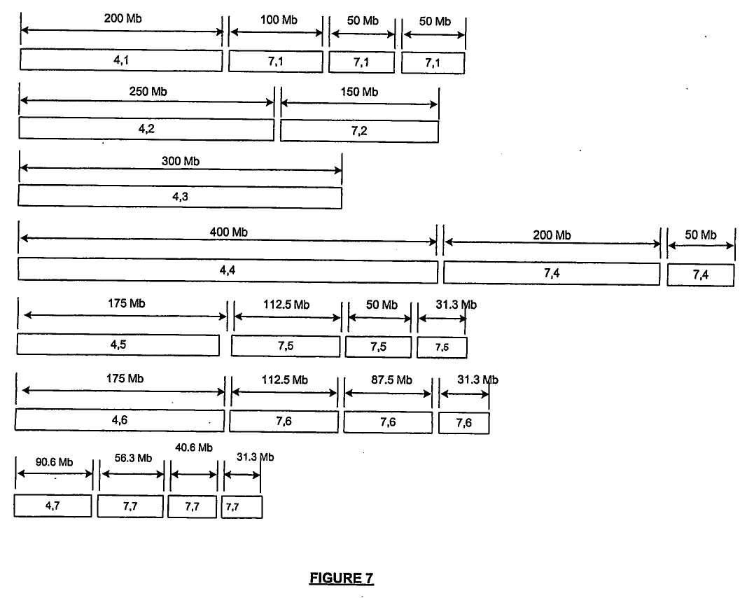

The seven delivery jobs shown in FIGS. 8A-8G vary in size based on the amount of time required to send job data through the forward channel bandwidth. The size of the forward channel bandwidth size is not significant, but, for the exemplary embodiment shown in FIGS. 8A-8G, the assigned forward channel bandwidth size is fixed. Variable multicast delivery job sizes are shown in the embodiment of FIGS. 8A-8G. FIG. 7 illustrates the relative size of the data to be delivered in step P4 of each call session, as well as step P7 for any Data-Resend-Cycles of a call session, in mega bits (Mb).

In the exemplary embodiment, the forward channel is assigned a fixed bandwidth of 10 Mbps (mega bits per second). The time required to send a job through the forward channel is determined by the size of the job divided by the bandwidth. This relative measurement is used throughout FIGS. 8A-8G (as well as FIGS. 9A-9F). Associating elapsed time with bits is applicable to any data sent through a forward channel with a fixed bandwidth capacity, and this measurement is also used to relate the relative size of other process steps, such as P2, P5, and P8, in the exemplary eight-step multicast call session discussed herein.

As shown in FIGS. 8A-8G, when any call session is in either a P3 or P6 state there is another call session ready to send data through the forward channel. There are periods where the forward channel bandwidth is not used as the pipeline is initially filling to its predefined depth and when the pipeline is emptying, which is common behavior for systems employing pipeline architecture. Pipeline architectures achieve maximum efficiency once the pipeline is filled and maintain these efficiency gains as long as the pipeline remains full.

In order to compare the forward channel bandwidth utilization and efficiency gains achieved in the exemplary embodiment of the invention shown in FIGS. 8A-8G, another multicast delivery of multiple call sessions is shown in FIGS. 9A-9F. The operational parameters for the multicast delivery shown in FIGS. 9A-9F are the same as those for the embodiment of the invention shown in FIGS. 8A-8G except that the multicast delivery uses serialized process flow instead of a token-controlled pipeline process. As can be seen in FIGS. 9A-9F, the forward channel bandwidth utilization is much lower than that in the exemplary embodiment of the invention shown in FIGS. 8A-8G. Additionally, for the same number of multicast delivery jobs and call session operation flow, as shown in FIG. 7 and Table 1, the time required to complete delivery of all seven call sessions is longer when using the serialized process flow of FIGS. 9A-9F: 647 seconds (FIGS. 9A-9F) compared to 395 seconds (FIGS. 8A-8G).

In the exemplary embodiment shown in FIGS. 8A-8G, all session data and control is contained in the same channel, allowing channel assignment resources to be maximized when compared with out of channel control methods that reduce the number of available channels for call session data by at least one because at least one channel is used for sending control messages. Alternative methods and systems for improving forward channel bandwidth utilization apply out-of-band control rather than the in-band control shown in FIGS. 8A-8G. In such alternative methods and systems, call session protocol is segmented into process steps that set up a call session and process steps that include actual call session dialog between a multicast server and clients. An embodiment of this invention employing out-of-band control includes dedicating a first set of forward channel packet addresses for call session set up messaging only and a second set of forward channel packet addresses for the pipelined multicast call session dialog. For example, using the exemplary call session process steps shown in FIG. 5, out-of-band control may be implemented as follows: (1) map process steps P2, P5, and P8 to a dedicated DVB PID value (address); and (2) map process steps P4 and P7 to a DVB PID value from a pool of available DVB PID values that are used for simultaneous call sessions that are pipelined. With out-of-band control, clients must keep track of which control messages received via the assigned DVB PID belong to which active call session in the pipeline. This added complexity does not exist in in-band control because call data received by clients over a particular DVB PID belongs to only one call session.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope.

What is claimed is:

1. A method for multicast delivery of a plurality of call sessions, each call session comprising at least one send data process step and at least one wait process step, the method comprising:
(a) providing a send token that controls which of the plurality of call sessions sends data through the forward channel;
(b) moving the send token to a first call session at a send data process step;
(c) upon reaching a wait process step of the first call session, moving the send token to a second call session at a send data process step;
(d) upon reaching a wait process step of the second call session or any subsequent wait process step of any of the plurality of call sessions, moving the send token to an active call session that is at a second or subsequent send data process step or, if no active call sessions are at a send data process step, moving the send token to an uninitiated call session of the plurality of call sessions; and
(e) repeating (d) until delivery of each of the plurality of call sessions is complete.

2. The method of claim 1, where the telecommunications network is a one-to-many internet protocol network with a satellite forward channel and a terrestrial back channel.

3. The method of claim 1, wherein (d) further comprises moving the send token to an active call session at a second or subsequent send data process step based on a priority scheme.

4. The method of claim 3, wherein the priority scheme is that the earliest initiated call session receives the send token when the send token becomes available.

5. The method of claim 1, wherein (d) further comprises moving the send token to an uninitiated call session according to an order in a queue of uninitiated call sessions.

6. The method according to claim 1, farther comprising providing a second send token such that two call sessions may send data simultaneously through a forward channel of the network.
